(19) United States
(12) Patent Application Publication
(10) Pub. No.: US 2007/0226632 A1
(43) Pub. Date: Sep. 27, 2007

(54) Method, electronic device and computer program product for enhancing contact list functionality

(75) Inventors: Esa Erola, Kauniainen (FI); Patrik Gustafsson, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/385,188

(22) Filed: Mar. 21, 2006

(51) Int. Cl. G06F 3/00

(52) U.S. Cl. 715/739; 715/752

(57) ABSTRACT

A method, electronic device and computer program product are provided for extending the functionality of an electronic device phonebook or list of contacts. In particular, certain configurable routines or sets of instructions associated with and unique to respective contact entries in the contact list are generated and embedded, or included, in the entry. When a user selects the contact entry from his or her contact list in order to establish a connection with the corresponding contact (e.g., to initiate a voice call with the person or to send an Instant Message (IM), Short Message Service (SMS) or Multimedia Messaging Service (MMS) message, or E-mail to the contact), the electronic device will detect the presence of the routine and will execute the instructions prior to or instead of establishing the requested connection.

### FIELD OF INVENTION

Exemplary embodiments of the present invention relate generally to electronic device contact lists or phonebooks and, more particularly, to a technique for improving or enhancing the functionality of that contact list or phonebook.

### BACKGROUND OF THE INVENTION

As more and more people rely on their electronic devices, including, for example, their cellular telephones, personal digital assistants (PDAs), personal computers (PCs), laptops, pagers, and the like, they are relying less and less on outdated “paper and pen” methods of communicating with their friends, family members and colleagues. As a result, they are also relying less on paper and pen methods of storing contact information associated with those parties. Instead of maintaining a physical address book in order to keep track of all of the contact information for various individuals or businesses, people are storing phone numbers, addresses, E-mail addresses, and the like, in various applications on their electronic devices.

An example of such an application is the Contacts application offered by Microsoft Outlook. Using this application, individuals can create, store and communicate electronic business cards (e.g., Versitcards or vCards) including information, such as, an individual's name, job title, company, business/home/fax/mobile phone number, business/home address and/or E-mail address. A vCard is essentially an electronic business card that follows a defined file format standard (See http://www.imc.org/pdi/vcard-21.txt) and may be communicated to other parties, for example, via E-mail messages and/or the World Wide Web. Another example is a simple phonebook application installed on a mobile or cellular telephone that enables the mobile phone user to create an entry for each of his or her contacts that lists that contact's home, mobile and/or business telephone number.

Using these applications, people can keep an electronic record of the contact information of their friends, family members and colleagues, as well as various businesses or services they contact frequently. In addition, these applications may make the process of actually communicating with a respective contact much faster and easier. In particular, the user is often able to simply select the contact entry in the particular application being used, in order to, for example, initiate a voice call to the corresponding phone number, or send an E-mail, Instant Message (IM) or Short Message Service (SMS) or Multimedia Messaging Service (MMS) message to the corresponding E-mail address.

In many instances, however, it may be beneficial for certain actions or routines to be performed with respect to a selected contact, prior to the establishment of the connection (e.g., the voice call, E-mail or message) between the user and the selected contact. The desired actions or routines will vary depending upon the contact. For example, where a person desires to call a customer service call center regarding a problem he or she is having with his or her cellular telephone, it may be beneficial for that person to be able to upload, for example, diagnostic information about the cellular telephone to a server associated with the call center, prior to actually conducting the voice call. This would enable the call center to have all of the information necessary to help the individual prior to being connected with the caller.

A need, therefore, exists for a way to enhance the functionality of electronic device phonebooks or contact lists in a manner that enables certain actions or routines to be performed upon selection of a particular contact entry in the contact list, prior to establishment of a connection to the corresponding contact, wherein the actions or routines are unique or specific to the contact entry selected.

### BRIEF SUMMARY OF THE INVENTION

In general, exemplary embodiments of the present invention provide an improvement over the known prior art by, among other things, providing a method, mobile station and computer program product for extending the functionality of an electronic device phonebook or list of contacts. In particular, according to exemplary embodiments of the present invention, certain configurable routines or sets of instructions associated with and unique to respective contact entries in the contact list are generated and embedded, or included, in or otherwise associated with the entry. When a user selects the contact entry from his or her contact list in order to establish a connection with the corresponding contact (e.g., to initiate a voice call with the person or to send an Instant Message (IM), Short Message Service (SMS) or Multimedia Messaging Service (MMS) message, or E-mail to the contact), the electronic device will detect the presence of the routine and will execute the instructions prior to or instead of establishing the requested connection.

In accordance with one aspect of the invention, a method is provided of extending functionality of an electronic device contact list. In one exemplary embodiment, the method includes: (1) receiving a selection of at least one of a plurality of contact entries in the electronic device contact list, wherein the at least one contact entry corresponds with a respective at least one contact; (2) detecting an override sequence associated with the at least one contact entry selected, wherein the override sequence comprises one or more computer programming instructions; and (3) executing the one or more instructions prior to or instead of establishing a connection with the at least one corresponding contact.

In one exemplary embodiment, different override sequences are associated with different ones of the plurality of contact entries in the contact list. In another exemplary embodiment, receiving a selection of at least one of a plurality of contact entries comprises receiving a selection of at least one phone number associated with the respective at least one corresponding contact. In another exemplary embodiment, receiving a selection comprises receiving a selection of at least one E-mail address associated with the respective at least one corresponding contact.

In one exemplary embodiment, detecting an override sequence comprises detecting a code included in the at least one contact entry that indicates than an override sequence is associated with the at least one contact entry. Respective contact entries of the plurality of contact entries, in one exemplary embodiment, comprise a vCard including at least one of a name, a phone number or an E-mail address associated with the respective corresponding contacts.

The method of one exemplary embodiment further includes generating an override sequence and associating the override sequence that is generated with at least one contact entry prior to receiving a selection. The method of another exemplary embodiment further includes establishing a connection with the at least one corresponding contact following execution of the one or more instructions. Establishing a connection may, in one exemplary embodiment, comprise initiating a voice call between the electronic device and the at least one corresponding contact. Alternatively, in another exemplary embodiment, establishing a connection comprises generating at least one of an Instant Message (IM), Short Message Server (SMS) message, Multimedia Messaging Service (MMS) message, or E-mail, and transmitting the IM, SMS message, MMS message or E-mail to the at least one corresponding contact. In yet another exemplary embodiment, the at least one contact entry comprises a web page associated with the at least one corresponding contact, and establishing a connection comprises downloading a web page from the web address.

According to another aspect of the invention, an electronic device is provided that is capable of extending functionality of a contact list. In one exemplary embodiment the electronic device includes a processor and a memory in communication with the processor that stores a contact list comprising a plurality of contact entries corresponding with respective contacts. The memory further stores an application executable by the processor, wherein the application is configured, upon execution, to: (1) receive a selection of at least one of the plurality of contact entries corresponding with a respective at least one contact; (2) detect an override sequence associated with the at least one contact entry selected, wherein the override sequence comprises one or more computer programming instructions; and (3) execute the one or more instructions prior to or instead of establishing a connection with the at least one corresponding contact.

In one exemplary embodiment, respective ones of the plurality of contact entries comprise at least one of a name, phone number or E-mail address associated with the corresponding contact. The electronic device of this exemplary embodiment may further comprise a display device in communication with the processor and configured to display the at least one of a name, phone number or E-mail address.

In another exemplary embodiment, the electronic device memory further stores a scripting engine comprising a set of computer programming instructions configured to generate an override sequence and to associate the override sequence with a respective contact entry.

In accordance with yet another aspect of the invention a computer program product is provided for extending functionality of an electronic device contact list. The computer program product contains at least one computer-readable storage medium having computer-readable program code portions stored therein. The computer-readable program code portions of one exemplary embodiment include: (1) a first executable portion for receiving a selection of at least one of a plurality of contact entries in the electronic device contact list, wherein the at least one contact entry corresponds with a respective at least one contact; (2) a second executable portion for detecting an override sequence associated with the at least one contact entry selected, wherein the override sequence comprises one or more computer programming instructions; and (3) a third executable portion for executing the one or more instructions prior to or instead of establishing a connection with the at least one corresponding contact.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a flow chart illustrating the steps which may be taken in order to enhance the functionality of a mobile device phonebook in accordance with exemplary embodiments of the present invention;

FIG. 2 is a block diagram of one type of system that would benefit from exemplary embodiments of the present invention; and

FIG. 3 is a schematic block diagram of a mobile station capable of operating in accordance with an exemplary embodiment of the present invention;

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview:

In general, exemplary embodiments of the present invention provide a method, electronic device and computer program product for extending the functionality of an electronic device (e.g., telephone, cellular telephone, personal digital assistant (PDA), personal computer (PC), laptop, etc.) phonebook or list of contacts in order to enable certain configurable routines to be executed prior to, or instead of, establishing a connection with a contact selected from the phonebook or contact list. Establishing a connection may include, for example, initiating a voice call with or sending an IM, SMS or MMS message, or E-mail to the selected contact. In addition, establishing a connection may comprise downloading a web page from a given web address (e.g., where a web address/URL is also included in the vCard or similar contact entry in addition to, or instead of, one or more phone numbers, E-mail addresses, etc.) As used herein, phonebook and contact list (or list of contacts) are used interchangeably and the use of either phonebook or contact list should therefore be understood to encompass both a phonebook and a contact list.

In particular, according to exemplary embodiments of the present invention, a routine or set of instructions may be defined and included as part of a respective contact entry in a user's electronic device phonebook or contact list. The contact entry may, for example, comprise a vCard, or other similar electronic business card. When a user selects an entry in his or her phonebook that includes such a separately defined and configured routine to be performed, the electronic device will detect the presence of the routine and will execute the instructions prior to (or instead of) initiating a connection with the selected contact. The user may select the entry for the purpose of initiating a voice call with the corresponding contact, or for the purpose of sending a message, such as an IM, SMS or MMS message, or an E-mail to the contact person. Alternatively, the user may select the entry in order to download a web page from a web address included in the contact entry.

A different routine or set of instructions may be defined for each contact entry or for group(s) of contact entries with the instructions being designed to cause any number of actions to be taken prior to, or instead of, establishing the desired connection. Alternatively, the same or similar routine may be used for multiple contact entries. For example, according to one exemplary embodiment, a default routine or set of instructions may be defined and used where a particular contact entry does not have a corresponding routine or set of instructions. Similarly, a template vCard or similar contact entry having this default routine associated therewith may be available for use when creating new vCards or similar contact entries.

The routines or instructions may provide, for example, a priority to respective phone numbers associated with a particular contact, wherein the priorities may be time dependent (e.g., the contact's home phone number may be given priority over his or her work phone number during certain periods of the day). Alternatively, or in addition, the routines or instructions may provide presence or context sensitive rules, such as specifying what networks or services can or should be used depending upon where the user (or caller) is located.

According to one exemplary embodiment, a scripting engine, or a program module or set of computer programming instructions stored in memory on the electronic device, may be configured to create the set of computer programming instructions, referred to herein as an escape/override sequence, and to embed, include or otherwise associate the escape/override sequence with the vCard, or other similar contact entry. Alternatively, the set of computer programming instructions that define the escape/override sequence may be created in other manners including manual creation of the escape/override sequence by the individual identified by the contact entry, or by a technical support group tasked with writing such computer programming instructions for various individuals. Regardless of its origin, the presence of the escape/override sequence in the contact entry will be detected by the electronic device and will cause the electronic device to “override” a call or message (e.g., IM, SMS, MMS or E-mail) initiation request received from the user (i.e., when the user selects an entry from his or her contact list or phonebook) and execute the embedded instructions prior to or instead of completing the call or message.

Exemplary Use Cases:

To illustrate, the following provides a few examples of how the escape/override sequence may be used in accordance with exemplary embodiments of the present invention. As one of ordinary skill in the art will recognize, however, any number of other routines or sets of instructions may similarly be generated and embedded in a contact entry without departing from the spirit and scope of the present invention.

In one exemplary embodiment, a user may have the number to the mobile device manufacturer's, network operator's customer service call center or corporate IM support call center stored in his or her phone. In addition to the number itself, a script or escape/override sequence may be stored in the contact entry or vCard in the phonebook or contact list that instructs the mobile device to perform various tasks in response to selection of the respective contact entry and prior to connecting the user to the call center. These tasks may include, for example, uploading diagnostic information about the mobile device to a server associated with the customer service call center. In this instance, the override sequence may include a URL address of the server, as well as an indication of what information should be uploaded. Alternatively, the script itself may only include an instruction to initiate the mobile device browser and to connect to a particular URL, wherein the remaining instructions will be provided by the web site. In yet another alternative, the script may include an email address associated with the server and instruct the mobile device to transmit the diagnostic information via E-mail or Instant Message. In any case, once the data has been uploaded, the mobile device may then connect the user to the call center using the stored phone number (or another number provided by the server).

Another example of how the escape/override sequence may be used is to incorporate an escape/override sequence in the contact entry or vCard of a service or business that indicates the hours of operation of the particular service or business (e.g., the IT help desk for the electronic device user's employer), as well as alternative instructions to apply where the user attempts to call the service or business after hours. For example, the IT help desk may have an associated web site where employees can go after hours to get help. In this instance, the vCard of the help desk may include instructions to, instead of connecting the user directly to the help desk, browse to the help desk web site where the hours of operation and alternative phone numbers are indicated, and the user can search for help him/herself.

In yet another example, an employer may generate an escape/override sequence to include with each contact entry in an employee's work phone or other electronic device that causes the electronic device to always use, for example, Voice over Internet Protocol (VoIP), instead of the normal cellular network, when the employee attempts to make a call while connected to the Wireless Local Area Network (WLAN). In another example, the escape/override sequence may cause the electronic device to connect to a WLAN and to use the WLAN for calling or communicating, instead of or in addition to a cellular network, when the electronic device hears a signal from the WLAN.

Method of Enhancing the Functionality of a Phone Book:

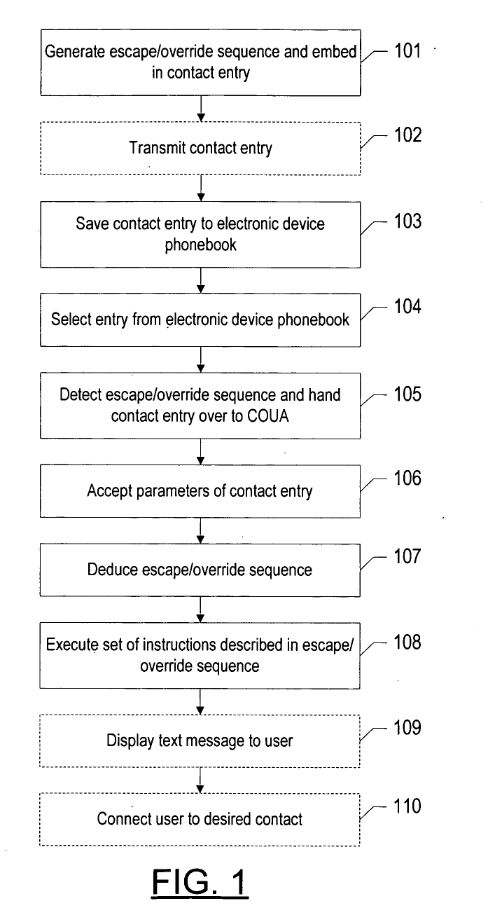

Reference is now made to FIG. 1, which illustrates the steps which may be taken in order to implement one exemplary embodiment of the present invention. As shown, the process begins at Step 101, where a party generates an escape/override sequence consisting, for example, of a set of computer programming instructions, and embeds the generated sequence in a contact entry or entries, such as a vCard(s). As noted above, the contact entry may include name and address information, as well as phone numbers, E-mail addresses, and the like, associated with a particular individual, business or service.

The party generating the sequence and contact entry may be the contact him/her/itself, such as a friend, colleague, family member, business or service center (e.g., the mobile device customer service call center, phone sales call center, or an employer's IT help desk), in which case the contact would then transmit the contact entry (e.g., vCard) to the intended recipient (i.e., the electronic device user) (optional Step 102). Alternatively, the party generating the escape/override sequence and contact entry may be the electronic device user him/herself. In this instance, Step 102 would not be performed, and the next step is to save the contact entry to the electronic device contact list or phonebook (Step 103). In yet another embodiment, the contact entry (e.g., vCard) and corresponding escape/override sequence may be generated by either the electronic device user or the contact him/herself using, for example, a personal computer (PC) or laptop, and then uploaded to an Internet or Intranet site, from which the contact entry can later be downloaded to the same or different electronic device (e.g., a cell phone, PDA, or the like) for use in relation to a phonebook or contact list. As a result, in this exemplary embodiment, not shown, prior to saving the entry to the electronic device contact list or phonebook (Step 203), the method may include uploading the contact entry to the web site and later downloading the contact entry to an electronic device. In still another exemplary embodiment, the electronic device user may receive the vCard and corresponding escape/override sequence associated with a particular contact in response to contacting directory assistance or support (e.g., via voice call or browsing to a corresponding web site) to obtain contact information for that contact.

As noted above, in one exemplary embodiment, a scripting engine comprising a program module or set of computer programming instructions stored on the electronic device may be configured to generate the escape/override sequence and to embed the generated sequence in the contact entry or vCard.

As discussed above, the escape/override sequence defines a set of rules or parameters to be applied prior to, or instead of, initiating a voice call (or other connection) to the contact corresponding with the contact entry. For example, an individual (referred to herein as “the contact”) may create a contact entry or vCard for him/herself that defines how that contact can best be reached at various times throughout the week. He or she may then send the contact entry to his or her friends. When the person receiving the contact entry selects the received contact entry from his or her phonebook or contact list, the included escape/override sequence will instruct the caller's electronic device as to which phone number to use in order to have the best chance of contacting the contact. The script may, for example, read (in an appropriate coding language):
IF, Monday through Friday, 8 AM to 6 PM, THEN call work phone number (404)123-4567;
ELSE, IF Monday through Friday 7-8 AM or 6-8 PM, THEN call cellular phone number (404)555-1212;
ELSE, call home phone number (404)343-7777.

In another exemplary embodiment, wherein the contact entry is associated with a help desk, the script may read (in an appropriate coding language), for example:
First connect to this ULR (www.helpdesk) for diagnostics upload of predefined types of diagnostic information, and then make a voice call to the server given phone number. If no phone number is received from the server, then the default phone number in the contacts object should be used.

The forgoing Steps 101-103 are repeated indefinitely as the user continues to build a contact list or phonebook including a plurality of contact entries, wherein one or more of the entries have a corresponding escape/override sequence. As noted above, a user may build his or her contact list or phonebook by generating the contact entries him/herself, receiving the contact entries directly from the contact him/herself or from directory assistance or support, or downloading the contact entries from an Internet or Intranet site to which the contact entries were previously uploaded.

In Step 104, the user selects an entry from his or her phonebook or contact list in order to initiate a voice call with, or otherwise contact, the corresponding contact. In one exemplary embodiment, this may be done by scrolling through a list of phone numbers and/or contact names displayed on the electronic device and highlighting the number and/or name associated with the desired contact. In another exemplary embodiment, where the electronic device responds to voice activation, the selection may be made by speaking the number and/or name. In yet another exemplary embodiment, the user may select multiple contact entries in order to, for example, initiate a group call (i.e., conference call) between three or more individuals. The override/escape sequence of this exemplary embodiment may thus be used, for example, to send information to the various parties prior to connecting the conference call (e.g., the names and numbers of the parties participating).

In yet another exemplary embodiment, where the user wishes to send an E-mail, IM, SMS or MMS message, or the like, to the contact, selecting an entry in the contact list may comprise selecting the E-mail address associated with the contact.

Once the user has made his/or her selection, in Step 105, if the entry selected has an escape/override sequence embedded or included in it, the electronic device will detect the presence of the sequence and will hand the contact entry over to a Contact Override User Agent (COUA). In one exemplary embodiment, the phone number field of the vCard may have the value “###-###-####nnn,” where nnn is a sequence of digits, or unique alphanumeric code, that indicates to the electronic device that a script or escape/override sequence is included. As one of ordinary skill in the art will recognize any number of other means may similarly be used for indicating the presence of an escape/override sequence to the electronic device.

While not shown, where the entry selected does not have an escape/override sequence embedded or included in it, the electronic device will detect this and may simply establish the requested connection with the selected contact. Alternatively, in one exemplary embodiment, the electronic device may still hand the contact entry over to the COUA, this time with instructions to perform the set of instructions included in a default escape/override sequence (discussed above).

In one exemplary embodiment, a COUA is a program module or set of computer programming instructions instantiated in memory on the electronic device that is configured to accept the parameters of a vCard, or similar contact entry, from the phonebook or contacts application on the electronic device (Step 106), to deduce the script or escape/override sequence to be used from the contact entry (Step 107), and to execute the set of instructions/perform the routine described in the sequence or script (Step 108).

Executing the instructions may include, for example, starting the browser in the electronic device, connecting to a URL address defined in the contact entry or vCard and uploading (or downloading) certain information that is defined by either the escape/override sequence, or the web site to which the browser connects. In another exemplary embodiment, the escape/override sequence may instruct the electronic device to start an IM session using the E-mail address included in the contact entry or vCard instead of initiating a voice call. Alternatively, or in addition, the COUA may execute instructions to display a text message on the electronic device indicating that the party the user is trying to call does not want to receive calls after a certain time on the weekdays and asking the caller to please call back at another time.

As noted above, the foregoing are only examples of various escape/override sequences that may be embedded in respective contact entries or vCards. Other similar sequences may likewise be generated and embedded without departing from the spirit and scope of the present invention.

Returning to FIG. 1, in one exemplary embodiment, in addition to performing the routine described in the escape/override sequence, the COUA may display a text message to the user describing the script/functionality to be performed—e.g., “A data upload will be performed before the voice call is established. Please be patient.” (Optional, Step 109).

Finally, once the set of instructions included in the escape/override sequence has been executed, the COUA, or other program module operating on the electronic device (e.g., the phonebook or contacts application) will initiate the voice call originally requested by the user, or otherwise connect the user to the desired contact (e.g., via IM, SMS, MMS or email), where still appropriate. (Optional Step 110).

Overall System and Electronic Device:

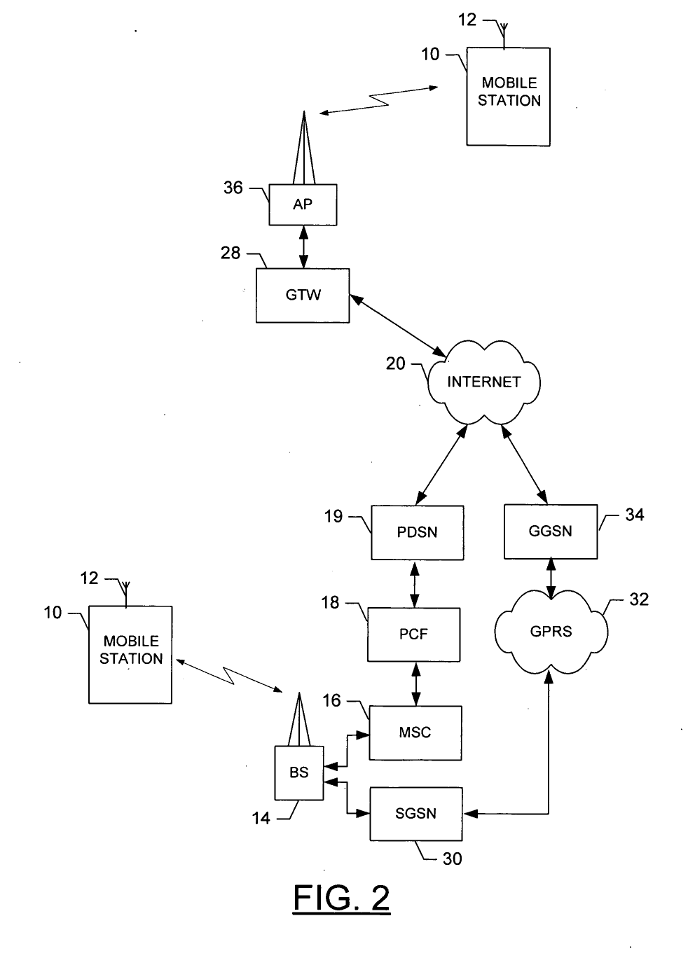

Referring to FIG. 2, an illustration is provided of one type of system that could provide the connectivity required to support the communications described above and that would benefit from exemplary embodiments of the present invention. As shown in FIG. 2, the system can include one or more mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 1) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 16, the AP's can be directly coupled to the Internet. In one embodiment, however, the APs are indirectly coupled to the Internet via a GTW 28. As will be appreciated, by directly or indirectly connecting the mobile stations and the processing elements and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile stations 10 to one or more processing elements across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques. Further, the mobile station 10 and the processing elements can be coupled to one or more electronic devices, such as printers, digital projectors and/or other multimedia capturing, producing and/or storing devices (e.g., other terminals).

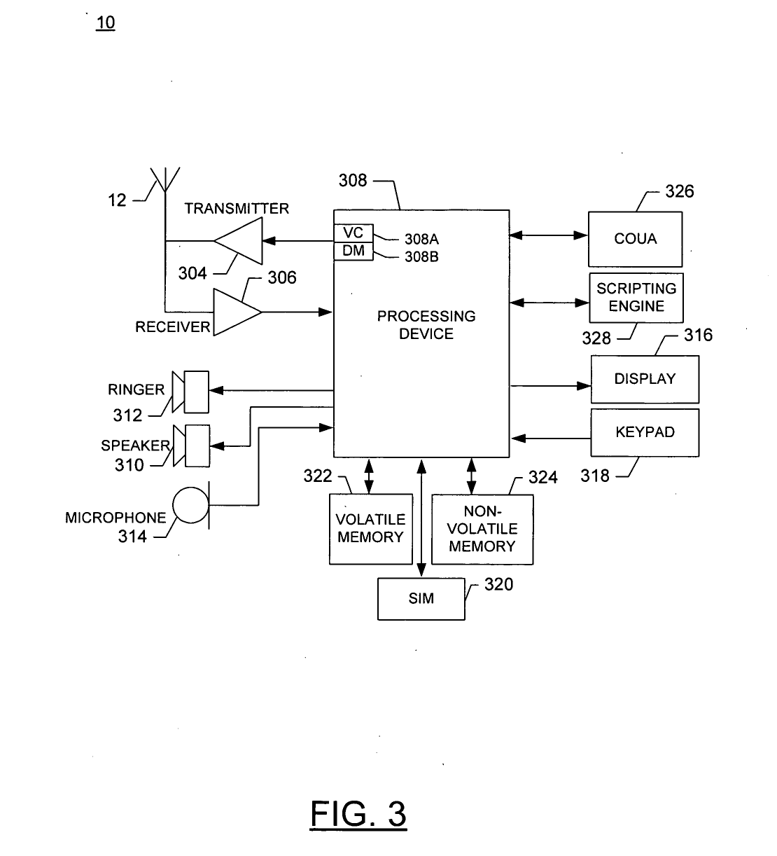

Reference is now made to FIG. 3, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 3, in addition to an antenna 302, the mobile station 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, as discussed above, in one embodiment of the present invention, the memory may store computer program code for receiving a selection of a contact entry in the mobile device contact list or phone book from a user of the mobile device (e.g., by way of the user highlighting a name, phone number or email address associated with the contact and displayed on the mobile device display screen) and detecting an escape/override sequence associated with and unique to the contact entry selected. The computer program code may further comprise the COUA 326 configured to execute the one or more instructions described in the escape/override sequence. In one exemplary embodiment, the computer program code may further comprise the scripting engine 328 configured to generate the escape/override sequence and to embed or include the sequence in a respective contact entry.

The method, electronic device and computer program product of exemplary embodiments of the present invention are primarily described in conjunction with mobile communications applications. It should be understood, however, that the method, electronic device and computer program product of embodiments of the present invention can be utilized in conjunction with a variety of other applications, both in the mobile communications industries and outside of the mobile communications industries. For example, the method, electronic device and computer program product of exemplary embodiments of the present invention can be utilized in conjunction with wireline and/or wireless network (e.g., Internet) applications.

Conclusion:

As described above and as will be appreciated by one skilled in the art, embodiments of the present invention may be configured as a method or electronic device. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of extending functionality of an electronic device contact list, said method comprising:
receiving a selection of at least one of a plurality of contact entries in the electronic device contact list, said at least one contact entry corresponding with a respective at least one contact;
detecting an override sequence associated with the at least one contact entry selected, said override sequence comprising one or more computer programming instructions; and
executing the one or more instructions prior to or instead of establishing a connection with the at least one corresponding contact.

2. The method of claim 1, wherein different override sequences are associated with different ones of the plurality of contact entries in the contact list.

3. The method of claim 1, wherein receiving a selection of at least one of a plurality of contact entries comprises receiving a selection of at least one phone number associated with the respective at least one corresponding contact.

4. The method of claim 1, wherein receiving a selection of at least one of a plurality of contact entries comprises receiving a selection of at least one E-mail address associated with the respective at least one corresponding contact.

5. The method of claim 1, wherein detecting an override sequence comprises detecting a code included in the at least one contact entry, said code indicating that an override sequence is associated with the at least one contact entry.

6. The method of claim 1, wherein respective contact entries of the plurality of contact entries comprise a vCard comprising at least one of a name, a phone number or E-mail address associated with respective corresponding contacts.

7. The method of claim 1 further comprising:
generating an override sequence; and
associating the override sequence that is generated with at least one contact entry prior to receiving a selection.

8. The method of claim 1 further comprising:
establishing a connection with the at least one corresponding contact following execution of the one or more instructions.

9. The method of claim 8, wherein establishing a connection comprises initiating a voice call between the electronic device and the at least one corresponding contact.

10. The method of claim 8, wherein establishing a connection comprises:
generating at least one of an Instant Message (IM), Short Message Service (SMS) message, Multimedia Messaging Service (MMS) message, or E-mail; and
transmitting the IM, SMS message, MMS message or E-mail to the at least one corresponding contact.

11. The method of claim 8 wherein the at least one contact entry comprises a web address associated with the at least one corresponding contact, and wherein establishing a connection comprises downloading a web page from the web address.

12. An electronic device capable of extending functionality of a contact list, said electronic device comprising:
a processor; and
a memory in communication with the processor, said memory storing a contact list comprising a plurality of contact entries corresponding with respective contacts, said memory further storing an application executable by the processor, wherein the application is configured, upon execution, to:
receive a selection of at least one of the plurality of contact entries corresponding with a respective at least one contact;
detect an override sequence associated with the at least one contact entry selected, said override sequence comprising one or more computer programming instructions; and
execute the one or more instructions prior to or instead of establishing a connection with the at least one corresponding contact.

13. The electronic device of claim 12, wherein different override sequences are associated with different ones of the plurality of contact entries in the contact list.

14. The electronic device of claim 12, wherein respective ones of the plurality of contact entries comprise at least one of a name, phone number or E-mail address associated with the corresponding contact, and wherein said electronic device further comprises:
a display device in communication with the processor, said display device configured to display the at least one of a name, phone number or E-mail address.

15. The electronic device of claim 14, wherein receiving a selection of at least one contact entry comprises receiving a selection of at least one phone number displayed on the display device and associated with the respective at least one corresponding contact.

16. The electronic device of claim 14, wherein receiving a selection of at least one contact entry comprises receiving a selection of at least one E-mail address displayed on the display device and associated with the respective at least one corresponding contact.

17. The electronic device of claim 12, wherein detecting an override sequence comprises detecting a code included in the at least one contact entry, said code indicating that an override sequence is associated with the at least one contact entry.

18. The electronic device of claim 12, wherein respective contact entries of the plurality of contact entries comprise a vCard comprising at least one of a name, phone number or E-mail address associated with respective corresponding contacts.

19. The electronic device of claim 12 wherein said memory also stores a scripting engine comprising a set of computer programming instructions configured to generate an override sequence and to associate the override sequence with a respective contact entry.

20. The electronic device of claim 12, wherein the application is further configured, upon execution, to:
establish a connection with the at least one corresponding contact.

21. The electronic device of claim 20, wherein establishing a connection comprises initiating a voice call between the electronic device and the at least one corresponding contact.

22. The electronic device of claim 20, wherein, in order to establish a connection, the application is further configured, upon execution, to:
generate at least one of an Instant Message (IM), Short Message Service (SMS) message, Multimedia Messaging Service (MMS) message, or E-mail; and
transmit the IM, SMS message, MMS message, or E-mail to the at least one corresponding contact.

23. The electronic device of claim 20, wherein the at least one contact entry comprises a web address associated with the at least one corresponding contact, and wherein the electronic device further comprising:
a web browser configured to download a web page from the web address in order to establish a connection with the at least one corresponding contact.

24. A computer program product for extending functionality of an electronic device contact list, wherein the computer program product comprises at least one computer-readable storage medium having computer-readable program code portions stored therein, the computer-readable program code portions comprising:
a first executable portion for receiving a selection of at least one of a plurality of contact entries in the electronic device contact list, said at least one contact entry corresponding with a respective at least one contact;
a second executable portion for detecting an override sequence associated with the at least one contact entry selected, said override sequence comprising one or more computer programming instructions; and
a third executable portion for executing the one or more instructions prior to or instead of establishing a connection with the at least one corresponding contact.

25. The computer program product of claim 24, wherein different override sequences are associated with different ones of the plurality of contact entries in the contact list.

26. The computer program product of claim 24, wherein the first executable portion is further configured to receive a selection of at least one phone number associated with the respective at least one corresponding contact.

27. The computer program product of claim 24, wherein the first executable portion is further configured to receive a selection of at least one E-mail address associated with the respective at least one corresponding contact.

28. The computer program product of claim 24, wherein the second executable portion is further configured to detect a code included in the at least one contact entry, said code indicating that an override sequence is associated with the at least one contact entry.

29. The computer program product of claim 24, wherein respective contact entries of the plurality of contact entries comprise a vCard comprising at least one of a name, a phone number or E-mail address associated with respective corresponding contacts.

30. The computer program product of claim 24, wherein the computer-readable program code portions further comprise:
a fourth executable portion for generating an override sequence; and
a fifth executable portion for associating the override sequence with at least one contact entry.

31. The computer program product of claim 24, wherein the computer-readable program code portions further comprise:
a fourth executable portion for establishing a connection with the at least one corresponding contact.

32. The computer program product of claim 31, wherein the fourth executable portion is further configured to initiate a voice call between the electronic device and the at least one corresponding contact.

33. The computer program product of claim 31, wherein the fourth executable portion is further configured to establish a connection by:
generating at least one of an Instant Message (IM), Short Message Service (SMS) message), Multimedia Messaging Service (MMS) message, or E-mail; and
transmitting the IM, SMS message, MMS message or E-mail to the at least one corresponding contact.

34. The computer program product of claim 31, wherein the at least one contact entry comprises a web address associated with the at least one corresponding contact, and wherein the fourth executable portion is further configured to download a web page from the web address.
